(19) United States
(12) Patent Application Publication
(10) Pub. No.: US 2024/0280386 A1
(43) Pub. Date: Aug. 22, 2024

(54) MEASUREMENT SYSTEM, METHOD, AND MEASUREMENT APPLICATION DEVICE

(71) Applicant: Rohde & Schwarz GmbH & Co. KG, München (DE)

(72) Inventor: Bernhard STERZBACH, München (DE)

(21) Appl. No.: 18/171,039

(22) Filed: Feb. 17, 2023

(51) Int. Cl. G01D 5/39; H04L 9/08; H04L 9/32

(52) U.S. Cl. CPC G01D 5/39; H04L 9/0819; H04L 9/0838; H04L 9/3242; H04L 9/3247

(57) ABSTRACT

The present disclosure provides a measurement system comprising a measurement application device comprising a measurement data acquisition interface configured to acquire measurement data, a data storage, and a cryptographic data encoder communicatively coupled to the measurement data acquisition interface and the data storage, wherein the cryptographic data encoder is configured to cryptographically encode the acquired measurement data and to store the cryptographically encoded measurement data in the data storage, the measurement system further comprising a user interface comprising a measurement data interface configured to retrieve the cryptographically encoded measurement data from the data storage, a cryptographic data decoder coupled to the measurement data interface and configured to cryptographically decode the retrieved cryptographically encoded measurement data, and a user interaction unit configured to provide the user with means for interacting with the cryptographically decoded measurement data. The disclosure further relates to a method, and a respective measurement application device.

### TECHNICAL FIELD

The disclosure relates to a measurement system, a method, and a respective measurement application device.

### BACKGROUND

Although applicable to any type of measurement application device, the present disclosure will mainly be described in conjunction with measurement application devices for performing electrical or magnetic measurements on a device under test.

The development of modern electrical devices requires performing a plurality of different test measurements on prototypes during development, and may also require performing qualifying measurements during production of such devices.

Especially, in large production environments, no direct access to the measurement devices may be available, or measurement data may be stored for later analysis or for documentation purposes. Such data may be stored long-term externally e.g., on a cloud storage. Confidentiality of such measurement data is an important aspect in the industry.

Accordingly, there is a need for improving confidentiality of measurement data.

### SUMMARY

The above stated problem is solved by the features of the independent claims. It is understood, that independent claims of a claim category may be formed in analogy to the dependent claims of another claim category.

Accordingly, it is provided:

A measurement system comprising a measurement application device comprising a measurement data acquisition interface configured to acquire measurement data, a data storage, and a cryptographic data encoder communicatively coupled to the measurement data acquisition interface and the data storage, wherein the cryptographic data encoder is configured to cryptographically encode the acquired measurement data and to store the cryptographically encoded measurement data in the data storage. The measurement system further comprises a user interface comprising a measurement data interface configured to retrieve the cryptographically encoded measurement data from the data storage directly or indirectly, a cryptographic data decoder coupled to the measurement data interface and configured to cryptographically decode, also called decrypt, the retrieved cryptographically encoded measurement data, and a user interaction unit configured to provide the user with means for interacting with the cryptographically decoded measurement data.

Further, it is provided:

A method for operating a measurement system, the method comprising acquiring measurement data in a measurement application device, cryptographically encoding the acquired measurement data in the measurement application device, storing the cryptographically encoded measurement data, retrieving the stored cryptographically encoded measurement data, cryptographically decoding the retrieved cryptographically encoded measurement data, and providing a user with means for interacting with the cryptographically decoded measurement data.

Further, it is provided:

A measurement application device comprising a measurement data acquisition interface configured to acquire measurement data, a data storage, a cryptographic data encoder coupled to the measurement data acquisition interface and the data storage, wherein the cryptographic data encoder is configured to cryptographically encode the acquired measurement data and to store the cryptographically encoded measurement data in the data storage.

The present disclosure is based on the finding that confidentiality of measurement data may be an important aspect in the development and production of electronic devices.

In measurement devices for development or production of electronic devices, usually the measurement data is not protected against access by any external entity. For example, the measurement data stored in a digital oscilloscope may be easily accessed by any person with physical access to the oscilloscope, or via a communication interface, like a network interface. An oscilloscope may also allow storing measurement data on a network storage, which may also be unprotected or at least accessible by the operator of the network storage, like a cloud operator.

The present disclosure takes into account that users may want to protect the measurement data acquired with a measurement application device, and provides a respective measurement application device, a respective user interface, a respective measurement system, and a respective method.

It is understood, that any feature of the measurement application device explained in conjunction with a measurement application device being part of the measurement system may also be implemented in the measurement application device without the measurement system. The same applies to the user interface.

The measurement system comprises a measurement application device and a user interface. The measurement application device serves for acquiring measurement data and to this end comprises a measurement data acquisition section. The measurement data acquisition section is coupled to a cryptographic data encoder that cryptographically encodes the acquired measurement data and stores the cryptographically encoded measurement data in a data storage.

Any measurement data is, consequently, stored as cryptographically encoded measurement data directly after acquiring the measurement data. No cryptographically unencoded copy of the measurement data is stored in the data storage or any other memory element in the measurement application device.

The measurement application device may comprise any device that may be used in a measurement application or measurement system to acquire an input signal or to generate an output signal, or to perform additional or supporting functions in a measurement application. A measurement application, also called measurement setup or system, may e.g., comprise at least one or multiple different measurement application devices for performing electric, magnetic, or electromagnetic measurements, especially on single devices under test. Such electric, magnetic, or electromagnetic measurements may be performed in a measurement laboratory or in a production facility in the respective production line. A measurement application or measurement setup may serve to qualify the single devices under test i.e., to determine the proper electrical operation of the respective devices under test.

Measurement application devices to this end may comprise at least one signal acquisition section i.e., the measurement data acquisition section, for acquiring electric, magnetic, or electromagnetic signals to be measured from a device under test. Measurement application devices may also comprise at least one signal generation section for generating electric, magnetic, or electromagnetic signals that may be provided to the device under test. Such a signal acquisition section may comprise, but is not limited to, a front-end for acquiring, filtering, and attenuating or amplifying electrical signals. The signal generation section may comprise, but is not limited to, respective signal generators, amplifiers, and filters.

Further, when acquiring signals, measurement application devices may comprise a signal processing section that may process the acquired signals. Processing may comprise converting the acquired signals from analog to digital signals, and any other type of digital signal processing, for example, converting signals from the time-domain into the frequency-domain. The cryptographic data encoder may be provided in the signal processing section e.g., after the acquired signals are converted into digital measurement data. Of course, any other function that uses the measurement data may be implemented in the user interface.

In embodiments, the measurement application devices may comprise the user interface to display the acquired signals to a user and allow a user to control the measurement application devices, as well as to perform at least some of the above-mentioned functions of the signal processing section. Of course, a housing may be provided that comprises the elements of the measurement application device. It is understood, that further elements, like power supply circuitry, communication interfaces, and connectors for connecting measurement probes may be provided.

A measurement application device may be a stand-alone device that may be operated without any further element in a measurement application to perform tests on a device under test. Of course, communication capabilities may also be provided for the measurement application device to interact with other measurement application devices.

A measurement application device may comprise, for example, a signal acquisition device e.g., an oscilloscope, especially a digital oscilloscope, a spectrum analyzer, or a vector network analyzer. Such a measurement application device may also comprise a signal generation device e.g., a signal generator, especially an arbitrary signal generator or a vector signal generator. Further possible measurement application devices comprise devices like calibration standards, or measurement probe tips.

Of course, at least some of the possible functions, like signal acquisition and signal generation, may be combined in a single measurement application device.

In embodiments, the measurement application device may comprise pure data acquisition devices that are capable of acquiring an input signal and of providing the acquired input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface. The same applies to pure signal generation devices that may generate an output signal without comprising any user interface or configuration input elements. Instead, such signal generation devices may be operated remotely via a data connection.

The measurement data acquisition interface of the measurement application device may comprise any element that is required to acquire a signal to be measured and to convert the acquired signal into the measurement data for processing by the cryptographic data encoder.

The data storage in the measurement application device may comprise any type of memory unit or memory device, like for example a RAM, ROM, E(E)PROM, a hard disk, an SSD disk or the like. The memory may also be provided as part of a memory that is already present in the respective application i.e., in the measurement application device. The memory may, for example, be provided as a variable or an array of variables that is stored in a memory of the measurement application device.

The cryptographic data encoder may comprise at least one of specific integrated circuits, processors with respective computer readable instructions, ASICs, CPLDs, or FPGAs that serve for cryptographically encoding the measurement data.

With a measurement application device according to the present disclosure, the measurement data is cryptographically encoded directly after the measurement data is acquired. Accordingly, no unencrypted copy of the measurement data is stored in the measurement application device. In embodiments, an unencrypted copy may be stored in parallel to cryptographically encoding the measurement data.

In other embodiments, the encrypted copy of the measurement data may be generated upon user request or when a user finishes analyzing the measurement data at the measurement application device. That a user has finished analyzing the measurement data may be detected automatically by the measurement application device e.g., when the user actively indicates that he has finished, or when the user shuts down the measurement application device. The unencrypted copy may then be deleted after the encrypted copy is generated. This allows quick access for a user to the measurement data after it is acquired, and at the same time provides increased security of the measurement data in the measurement application device, especially after a user finished analyzing or processing his measurement data.

This allows the owner or user of the measurement application device to grant access to the measurement application device e.g., to support staff of the manufacturer of the measurement application device, without the risk of compromising the measurement data.

In a measurement system according to the present disclosure, the measurement application device may be coupled to a user interface. In this regard, the term user interface may refer to a device that provides the user with the capabilities to interact with the measurement data. Such a device may be a computer, PC, Tablet-PC, smartphone, or a dedicated device. A user interface, in addition to or instead of comprising a dedicated device, may also comprise a computer program or computer-readable instructions that when executed by a processor cause the processor to provide the user with the respective functionality. The user interface may also be provided as a website or webpage with the respective functionality from a respective server. In embodiments, the user interface may be provided as part of or integrated into the measurement application device.

The user interface comprises a measurement data interface. Such a measurement data interface may comprise any kind of wired and wireless communication interfaces, like for example a network communication interface, especially an Ethernet, wireless LAN or WIFI interface, a USB interface, a Bluetooth interface, an NFC interface, a visible or non-visible light-based interface, especially an infrared interface.

The measurement data interface may in embodiments also comprise a software-based interface, like an API, application programming interface. Such an interface may comprise, but is not limited to, a REST-interface, a JSON-based interface, A SOAP-interface, a CORBA-interface, an XML-based interface, or a remote procedure call interface.

After acquiring the measurement data, the measurement data interface provides the measurement data to the cryptographic data decoder for decoding, also called decrypting, the cryptographically encoded measurement data.

The cryptographic data decoder may comprise at least one of specific integrated circuits, processors with respective computer readable instructions, ASICs, CPLDs, or FPGAs that serve for cryptographically decoding the cryptographically encoded measurement data.

In embodiments, the cryptographic data decoder may be implemented as a kind of secure environment for decoding and handling the cryptographically encoded measurement data. Such a secure environment may comprise elements that are protected against data extraction by the surrounding environment. For example, in case that the user interface is implemented as an application, especially a local application or a HTML-based application or web application, those functions that are used to handle the cryptographically encoded measurement data may be encapsulated in a library, class or group that is secured accordingly.

After cryptographically decoding the cryptographically encoded measurement data, a user may interact with the measurement data via a user interaction unit.

The user interaction unit may e.g., comprise a display that shows the measurement data to the user. Of course, such a display may allow a user to zoom into and out of the measurement data or pan along the measurement data. The display may comprise a hardware display. In embodiments, the display may also comprise a software-based display e.g., a program window with the respective content that may be shown to a user.

In embodiments, the user interaction unit may also comprise functions that allow a user to modify the measurement data or calculate derived data from the measurement data. Such functions may comprise converting the measurement data from a time-domain into a frequency-domain or vice versa.

In embodiments, the user interaction unit may comprise a protected environment, like a secured virtual machine or a secured application that allows a user to load the measurement data into any adequate data processing program or function that may be provided in such a secured virtual machine or secured application. In an embodiment, a secured virtual machine or a secured application may comprise a spreadsheet tool for analyzing the measurement data, or a programming-language based data analysis package, like the Python Anaconda package. The virtual machine or application may e.g., be secured by verifying that no functions are present in the respective tool, program or package that allow transferring the measurement data to other entities.

With the measurement system of the present disclosure, measurement data may be stored and delivered to a user in an end-to-end encrypted fashion. Therefore, the measurement data is protected from the point of measurement to the user, who retrieves the data for analysis or inspection.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to the measurement system can be combined in all variations with each other and the disclosure of the description is not limited to the claim dependencies as specified in the claim set. Further, the features of the other independent claims may be combined with any of the features of the dependent claims relating to the measurement system in all variations.

In an embodiment, which can be combined with all other embodiments of the measurement system mentioned above or below, the measurement system may comprise a cryptographic key database configured to at least one of provide a cryptographic encryption key to the cryptographic data encoder for cryptographically encoding the measurement data, and provide a cryptographic decryption key to the cryptographic data decoder for cryptographically decoding the cryptographically encoded measurement data.

The cryptographic key database is the unit in the measurement system that provides the keys that are required for cryptographically encoding and decoding the measurement data i.e., the cryptographic encryption key and the cryptographic decryption key.

To this end, the cryptographic key database may comprise a hardware device or token. Such a device or token may be coupled to the measurement application device while acquiring the measurement data, and to the user interface when a user needs to operate on the measurement data. In embodiments, such hardware tokens may comprise, but are not limited to, chipcards, smartcards, USB devices, USB sticks, NFC tokens, and Bluetooth devices.

In embodiments, the cryptographic key database may comprise a network-connected database, like a server, that provides the measurement application device and the user interface with the cryptographic encryption key and the cryptographic decryption key, when needed. With such a cryptographic key database, the usage of the measurement data is not limited to a single user at a time. Instead, multiple users may be provided with the respective cryptographic encryption key and cryptographic decryption key. This, for example, allows a company that uses the measurement system to securely store measurement data, while at the same time allowing a specific group of employees to access the same measurement data. Of course, multiple of the above-mentioned hardware tokens could also be issued to the users.

In embodiments, the cryptographic key database may generate the required cryptographic encryption key and cryptographic decryption key internally. In addition, or as alternative, the cryptographic key database may also retrieve the required cryptographic encryption key and cryptographic decryption key from another external source.

The cryptographic key database may in embodiments be provided as a dedicated element e.g., a server, of the measurement system. In other embodiments, the cryptographic key database may also be provided in the measurement application device or in the user interface.

In embodiments, the measurement application device may permanently store the cryptographic encryption key. In other embodiments, the measurement application device may be provided with the cryptographic encryption key on request from the cryptographic key database. The cryptographic decryption key may be stored in the user interface permanently or may be provided to the user interface from the cryptographic key database on request.

In embodiments, the measurement application device may store multiple cryptographic encryption keys in an internal data storage, especially a protected data storage. Each key may e.g., be assigned to a respective credential, and users may provide the respective credentials to the measurement application device to load a respective one of the cryptographic encryption keys. The credential may comprise, but is not limited to, e.g., a password, a pin, and a hardware token.

This allows multiple users to use the same measurement application device and at the same time ensure confidentiality of the single users' measurement data.

In another embodiment, which can be combined with all other embodiments of the measurement system mentioned above or below, the cryptographic encryption key and the cryptographic decryption key are equal.

If both, the cryptographic encryption key, and the cryptographic decryption key, are equal, a symmetric encryption/decryption algorithm may be employed in the cryptographic data encoder, and the cryptographic data decoder.

In a further embodiment, which can be combined with all other embodiments of the measurement system mentioned above or below, the cryptographic encryption key and the cryptographic decryption key are different.

With a cryptographic encryption key that is different than the cryptographic decryption key, an asymmetric encryption/decryption algorithm may be employed in the cryptographic data encoder, and the cryptographic data decoder.

In such an embodiment, the cryptographic encryption key may comprise the public key of the key pair, and the cryptographic decryption key may comprise the private key of the key pair.

Using a public/private key encryption may e.g., be used if the public key i.e., the cryptographic encryption key, should easily be distributed to multiple recipients. A symmetric encryption may be used e.g., for long-term storage if the keys need not be distributed but may be kept hidden securely. Such a symmetrically encrypted measurement data may, for example, be stored as backup. The data encrypted with the public/private encryption key may be used for daily work. Of course, this is just an example.

In another embodiment, which can be combined with all other embodiments of the measurement system mentioned above or below, the cryptographic key database is configured to at least one of verify an authenticity of the measurement application device prior to providing the cryptographic encryption key to the cryptographic data encoder, and verify an authenticity of the user interface prior to providing the cryptographic decryption key to the cryptographic data decoder.

The cryptographic key database may be configured to only handle the cryptographic encryption key to authenticated measurement application devices, and the cryptographic decryption key only to authenticated user interfaces.

In such embodiments, the cryptographic key database may verify the authenticity of the measurement application device by requesting the measurement application device to provide respective credentials, like a password or a certificate.

The cryptographic key database may also verify the authenticity of the user interface. To verify the authenticity of the user interface, the cryptographic key database may use a password or certificate. In embodiments with program-based user interfaces or with parts of the user interface being implemented in software, the cryptographic key database may calculate or receive a hash value that is calculated for the user interface or the respective part, and compare the hash value to a respective list of allowed has values. The cryptographic key database may also verify a signature of the respective user interface or part of the user interface.

In embodiments with web- or program-based user interfaces or with parts of the user interface being implemented in software, the cryptographic key database may deliver the program-based user interfaces or the respective parts of the user interface that are implemented in software. In such embodiments, only the program that is delivered by the cryptographic key database may be provided with the cryptographic encryption key or cryptographic decryption key.

In a further embodiment, which can be combined with all other embodiments of the measurement system mentioned above or below, the user interface further comprises a cryptographic data encoder coupled to the user interaction unit and configured to cryptographically encode the measurement data after being manipulated in the user interaction unit according to respective user input.

The user interface, as indicated above, may not only serve to visualize the measurement data as acquired by the measurement application device. Instead, the user interface may also allow a user e.g., via the user interaction unit, to modify the measurement data or generate new data based on the measurement data, which in this regard is also comprised by the term “measurement data after being manipulated”.

With the cryptographic data encoder in the user interface, such modified measurement data or newly generated data may be protected with the same mechanism as the measurement data acquired in the measurement application device.

Regarding the cryptographic data encoder in the user interface, the information provided above and below regarding the cryptographic data encoder in the measurement application device applies mutatis mutandis.

In another embodiment, which can be combined with all other embodiments of the measurement system mentioned above or below, the cryptographic data encoder in the user interface is coupled to the measurement data interface and is configured to output the manipulated and cryptographically encoded measurement data via the measurement data interface.

After manipulating the measurement data, the user may want to provide the manipulated measurement data to other users. To this end, the cryptographic data encoder in the user interface may output the manipulated and cryptographically encoded measurement data via the measurement data interface.

In an embodiment, which can be combined with all other embodiments of the measurement system mentioned above or below, the measurement system may comprise a cryptographic key database configured to provide a cryptographic encryption key to the cryptographic data encoder of the user interface for cryptographically encoding the measurement data.

It is understood, that the cryptographic key database that provides the cryptographic encryption key to the cryptographic data encoder in the user interface may be the same cryptographic key database that provides the cryptographic encryption key to the cryptographic data encoder in the measurement application device. In embodiments, a dedicated cryptographic key database may also be provided.

The explanations provided above and below for the cryptographic key database that provides the cryptographic encryption key to the measurement application device may be applied mutatis mutandis to the cryptographic key database that provides the cryptographic encryption key to the cryptographic data encoder in the user interface.

In another embodiment, which can be combined with all other embodiments of the measurement system mentioned above or below, the measurement system may comprise a remote data storage communicatively coupled at least to the measurement application device, wherein the measurement application device is configured to transmit the cryptographically encoded measurement data to the remote data storage.

The remote data storage may be any kind of storage that may be accessed remotely e.g., via a communication interface, by the measurement application device. The remote data storage may also be implemented as a distributed system comprising a plurality of servers, optionally with a load balancer, that distributes the load over the servers. The remote data storage may also be provided as a so-called cloud or cloud-server system that implements the server via virtualization methods independently of the underlying hardware. The remote data storage may also comprise a dedicated storage server, or a network attached storage or NAS.

The measurement system of the present disclosure allows securely storing the acquired measurement data on any storage that is external to the measurement application device, since no unencrypted measurement data will be sent out of the measurement application device.

In embodiments, multiple or at least two different remote data storages may be provided. For example, a first remote data storage may be a cloud data storage external to the premises of the user of the measurement application device. Such a remote data storage may be used to store the measurement data encrypted with a private/public key encryption. A cloud data storage will allow any authorized user access to the cryptographically encoded measurement data independently of the current location of the user.

A second remote data storage may be provided on the premises of the user of the measurement application device. Such a remote data storage may be used e.g., to create a backup of the measurement data. The measurement data that is stored in this second remote data storage may be encrypted with a symmetric key encryption algorithm.

In embodiments, the user interface may retrieve the cryptographically encoded measurement data directly from the measurement application device e.g., via a communication interface.

In a further embodiment, which can be combined with all other embodiments of the measurement system mentioned above or below, the user interface is configured to retrieve the cryptographically encoded measurement data from the remote data storage.

If the cryptographically encoded measurement data is stored in a remote data storage, the user interface may retrieve the cryptographically encoded measurement data from that remote data storage instead of the measurement application device. Especially, if the measurement application device is located in another location than the user and the user interface, retrieving the cryptographically encoded measurement data from the remote data storage may easily be performed via a respective online access to the remote data storage. On the other hand, in such a situation it may be difficult for the user interface to access the measurement application device via a communication interface directly, since respective security measures like firewalls may be provided between the user interface and the measurement application device.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a measurement system according to the present disclosure;

FIG. 2 shows a block diagram of another embodiment of a measurement system according to the present disclosure;

FIG. 3 shows a block diagram of a further embodiment of a measurement system according to the present disclosure;

FIG. 4 shows a block diagram of another further embodiment of a measurement system according to the present disclosure;

FIG. 5 shows a block diagram of an embodiment of a measurement application device according to the present disclosure;

FIG. 6 shows a block diagram of another embodiment of a measurement application device according to the present disclosure; and

FIG. 7 shows a flow diagram of an embodiment of a method according to the present disclosure.

In the figures like reference signs denote like elements unless stated otherwise.

### DETAILED DESCRIPTION OF THE DRAWINGS

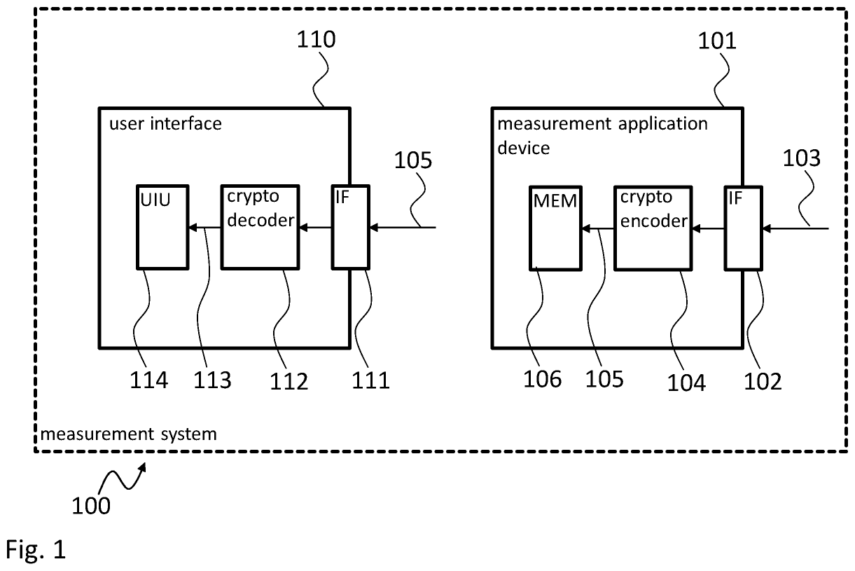

FIG. 1 shows a block diagram of a measurement system 100. The measurement system 100 comprises a measurement application device 101 and a user interface 110.

The measurement application device 101 comprises a measurement data acquisition interface 102 that is coupled to a cryptographic data encoder 104 that is coupled to a data storage 106.

The user interface 110 comprises a measurement data interface 111 that is coupled to a cryptographic data decoder 112 that is coupled to a user interaction unit 114.

During operation of the measurement system 100, the measurement application device 101 acquires measurement data 103 while performing a respective measurement on a device under test, also called DUT. The acquired measurement data 103 is provided to the cryptographic data encoder 104 that cryptographically encodes that acquired measurement data 103, and provides the cryptographically encoded measurement data 105 to the data storage 106.

After a set of cryptographically encoded measurement data 105 is stored in the data storage 106, the cryptographically encoded measurement data 105 may be further processed or used by a user via the user interface 110.

The user interface 110 may retrieve the cryptographically encoded measurement data 105 via the measurement data interface 111. In embodiments, the measurement data interface 111 may comprise a communication interface for communicating with the measurement application device 101 or another storage, as will be explained in more detail below. The measurement application device 101 to this end, may also comprise a respective communication interface. In embodiments, the measurement data interface 111 may, however, also comprise an interface for a memory device, like a USB interface, or a memory card interface. In such embodiments, the cryptographically encoded measurement data 105 may be provided to the user interface 110 by the user via the memory device. Of course, in such embodiments, the measurement application device 101 may also comprise a respective interface for such a memory device to store the cryptographically encoded measurement data 105 on the measurement device. In embodiments, an interface for a memory device may be present in parallel to a communication interface in the measurement application device 101 and the user interface 110.

In the user interface 110, the cryptographically encoded measurement data 105 is cryptographically decoded by the cryptographic data decoder 112. The cryptographically decoded measurement data 113 is provided to the user interaction unit 114 for at least one of viewing and manipulating of the cryptographically decoded measurement data 113 i.e., the digitized original measurement data 103, by the user.

As can be seen in FIG. 1, the measurement data 103 is converted into the cryptographically encoded measurement data 105 directly after acquisition of the measurement data 103 by the measurement data acquisition interface 102. Therefore, the measurement data 103 is only stored in encrypted form, even in the measurement application device 101. Therefore, for example, support staff or the manufacturer of the measurement application device 101 that need to access the measurement application device 101 cannot access the measurement data 103 since it is only stored as cryptographically encoded measurement data 105.

The cryptographically encoded measurement data 105 may only be accessed after successful decryption by the cryptographic data decoder 112.

In embodiments, the user interface 110 may be provided integrated into or as part of the measurement application device 101. A measurement system 100 may also comprise multiple user interfaces 110, wherein one of these may be integrated into or be part of the measurement application device 101.

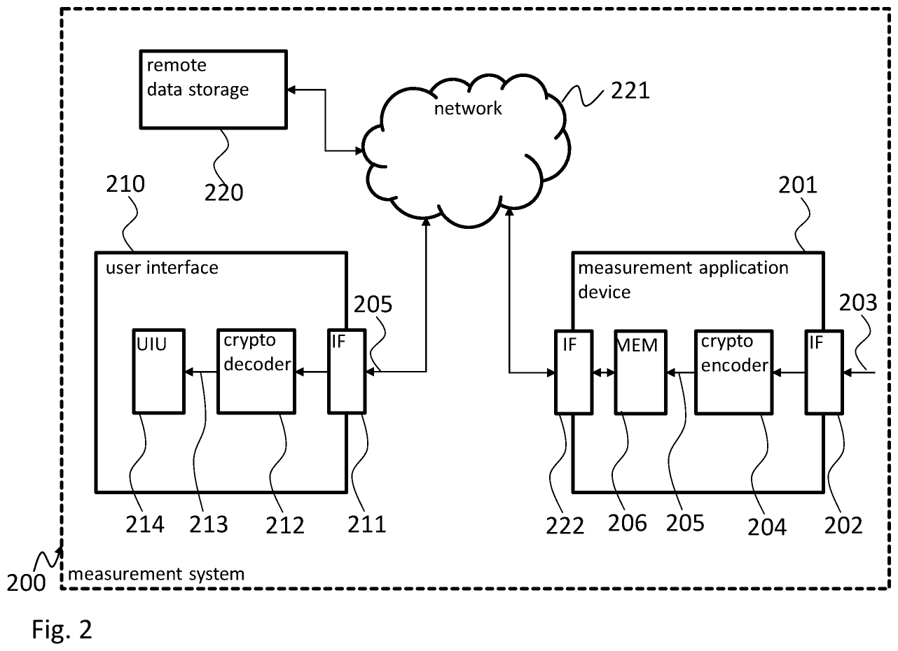

FIG. 2 shows a block diagram of another measurement system 200. The measurement system 200 is based on the measurement system 100. The measurement system 200, therefore, comprises a measurement application device 201 and a user interface 210. The measurement application device 201 comprises a measurement data acquisition interface 202 that is coupled to a cryptographic data encoder 204 that is coupled to a data storage 206. The user interface 210 comprises a measurement data interface 211 that is coupled to a cryptographic data decoder 212 that is coupled to a user interaction unit 214.

The explanations provided above, regarding the measurement system 100, the measurement application device 101 and the user interface 110, apply mutatis mutandis to the measurement system 200, the measurement application device 201, and the user interface 210, and its' respective elements.

In the measurement system 200, the measurement application device 201 further comprises a communication interface 222 that is coupled to the data storage 206. It is understood, that the communication interface 222 may be any kind of network interface or interface for a memory device, like also explained above or below.

The measurement system 200 further comprises a remote data storage 220 that is coupled to the measurement application device 201, and the user interface 210 via a network 221. It is understood, that the network 221 is optional, and that the remote data storage 220, the measurement application device 201, and the user interface 210 may also be coupled to each other directly. In embodiments, the network 221 may comprise at least one of a private network on premises of the user of the measurement application device 201 and/or the user interface 210, a public network, like the internet, and devices that are required to operate such a network, like switches, hubs, gateways, especially VPN gateways, and routers.

The remote data storage 220 may comprise a dedicated data storage server, a cloud data storage, or any other connected type of data storage. Since the measurement data 203 is encrypted inside of the measurement application device 201, the remote data storage 220 may, especially, be provided outside of the premises of the user of the measurement application device 201, and for example may be operated by another entity than the user. Consequently, any remote data storage offered by specialized storage providers may be chosen by the user of the measurement application device 201. In embodiments, the remote data storage 220 may be provided by the manufacturer of at least one of the measurement application device 201 and the user interface 210.

In embodiments, at least part of the functionality of the user interface 210 may be provided as an application. Such an application may be a native application that may be executed directly by a processor or an operating system of the user interface 210. In embodiments, such an application may at least in part comprise an interpreted application e.g., a web application or web page that comprises HTML and JavaScript program code and is executed by a web browser in the user interface 210. Such a user interface 210 may comprise at least one of a standard PC, a smartphone, a Table-PC, or a dedicated device.

In embodiments that comprise the user interface 210 at least in part being provided as web application or web page, that web application or web page may be provided by the remote data storage 220 or the cryptographic key database (see below). In such embodiments, the remote data storage 220 may comprise a web server that is capable of serving the respective web application or web page to the device that implements the user interface 210.

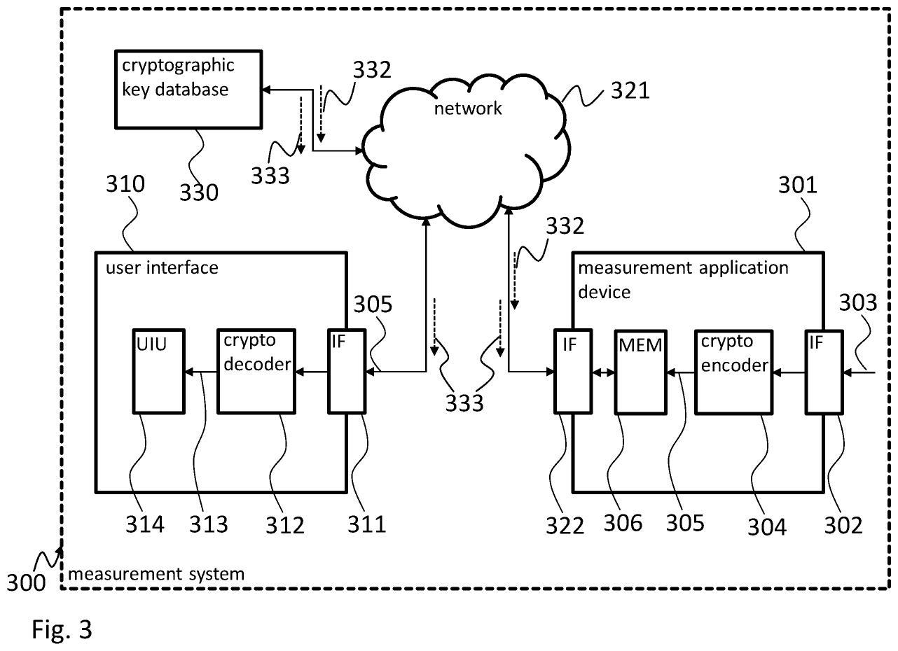

FIG. 3 shows a block diagram of a measurement system 300. The measurement system 300 is based on the measurement system 100. The measurement system 300, therefore, comprises a measurement application device 301 and a user interface 310. The measurement application device 301 comprises a measurement data acquisition interface 302 that is coupled to a cryptographic data encoder 304 that is coupled to a data storage 306. The user interface 310 comprises a measurement data interface 311 that is coupled to a cryptographic data decoder 312 that is coupled to a user interaction unit 314.

The explanations provided above, regarding the measurement system 100, the measurement application device 101 and the user interface 110, apply mutatis mutandis to the measurement system 300, the measurement application device 301, and the user interface 310, and its' respective elements.

In the measurement system 300, the measurement application device 301 further comprises a communication interface 322 that is coupled to the data storage 306. It is understood, that the communication interface 322 may be any kind of network interface or interface for a memory device, like also explained above or below.

The measurement system 300 further comprises a cryptographic key database 330 that is coupled to the measurement application device 301, and the user interface 310 via a network 321. The explanations provided above regarding the network 221 apply mutatis mutandis to the network 321.

The cryptographic key database 330 serves for providing cryptographic keys to the measurement application device 301, and the user interface 310 whenever they are required. To this end, the cryptographic key database 330 may generate the respective cryptographic keys internally or receive the cryptographic keys from another entity, especially an external trusted entity.

The cryptographic key database 330 will provide a cryptographic encryption key 332 to the measurement application device 301, especially the cryptographic data encoder 304. The cryptographic key database 330 will also provide a cryptographic decryption key 333 to the user interface 310, especially to the cryptographic data decoder 312.

In embodiments, the cryptographic key database 330 may provide the same kay as cryptographic encryption key 332, and as cryptographic decryption key 333. This is the case, if a symmetric encryption and decryption algorithm is used in the cryptographic data encoder 304, and the cryptographic data decoder 312.

In embodiments, the cryptographic key database 330 may provide different keys as cryptographic encryption key 332, and as cryptographic decryption key 333. This is the case, if an asymmetric encryption and decryption algorithm is used in the cryptographic data encoder 304, and the cryptographic data decoder 312. In such an embodiment, the cryptographic encryption key 332 may be the public key of a key pair, and the cryptographic decryption key 333 may be the secret key of a key pair.

In embodiments, the cryptographic key database 330 may always provide the same cryptographic encryption key 332 to a single measurement application device 301. In other embodiments, a different cryptographic encryption key 332 may be provided to each one of multiple users of the measurement application device 301. Of course, in such a multi-user setup, the cryptographic key database 330 may also provide the respective cryptographic decryption key 333 to multiple users of the user interface 310.

In the measurement system 300, the cryptographic key database 330 also provides the cryptographic decryption key 333 to the measurement application device 301, especially on request. This allows decrypting the cryptographically encoded measurement data 305 in the measurement application device 301 for viewing or manipulating by a user. A dedicated user interface 310 is not needed in such embodiments, but may be provided.

Although not explicitly show, it is understood, that the features of the measurement system 300, and the measurement system 200 may be combined, and that such a measurement system may comprise a cryptographic key database 330 and a remote data storage 220.

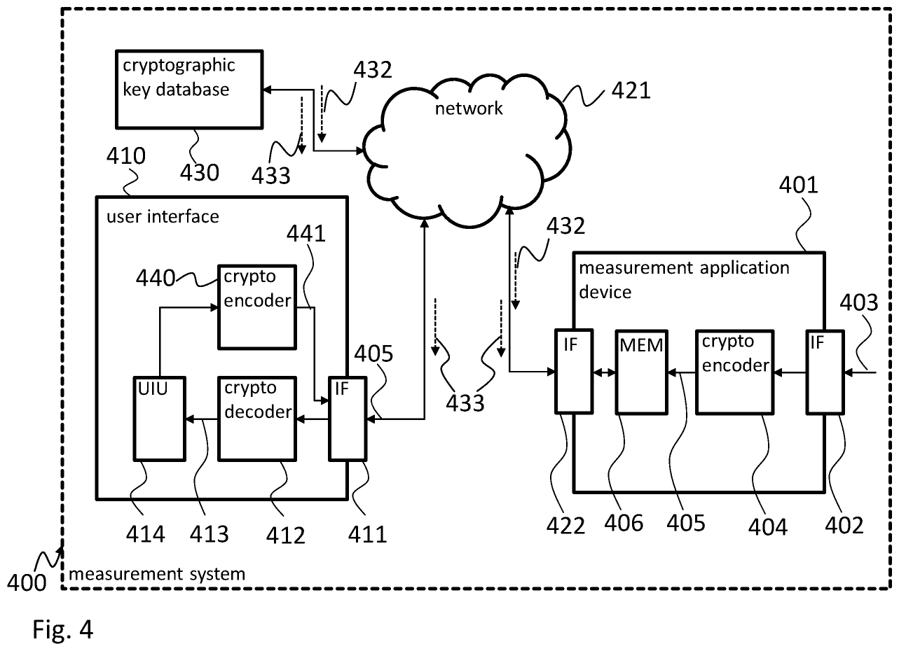

FIG. 4 shows a block diagram of a measurement system 400. The measurement system 400 is based on the measurement system 300. The measurement system 400, therefore, comprises a measurement application device 401 and a user interface 410. The measurement application device 401 comprises a measurement data acquisition interface 402 that is coupled to a cryptographic data encoder 404 that is coupled to a data storage 406. The user interface 410 comprises a measurement data interface 411 that is coupled to a cryptographic data decoder 412 that is coupled to a user interaction unit 414.

The measurement application device 401 further comprises a communication interface 422 that is coupled to the data storage 406. It is understood, that the communication interface 422 may be any kind of network interface or interface for a memory device, like also explained above or below.

The measurement system 400 further comprises a cryptographic key database 430 that is coupled to the measurement application device 401, and the user interface 410 via a network 421. The explanations provided above regarding the network 321 apply mutatis mutandis to the network 421.

In the measurement system 400, the user interface 410 further comprises a cryptographic data encoder 440 that is coupled in parallel to the cryptographic data decoder 412 between the measurement data interface 411, and the user interaction unit 414.

The cryptographic data encoder 440 may cryptographically encode measurement data after it is manipulated by a user in the user interaction unit 414. The user may, for example, generate new data from the cryptographically decoded measurement data 413, like a frequency-domain representation of the cryptographically decoded measurement data 413, or may perform any other calculation on the cryptographically decoded measurement data 413. The resulting data may then be cryptographically encoded by the cryptographic data encoder 440, and may be provided via the measurement data interface 411 to the measurement application device 401, or—if present—a respective remote data storage.

The explanations provided above, regarding the measurement system 300, the measurement application device 301 and the user interface 310, apply mutatis mutandis to the measurement system 400, the measurement application device 401, and the user interface 410, and its' respective elements.

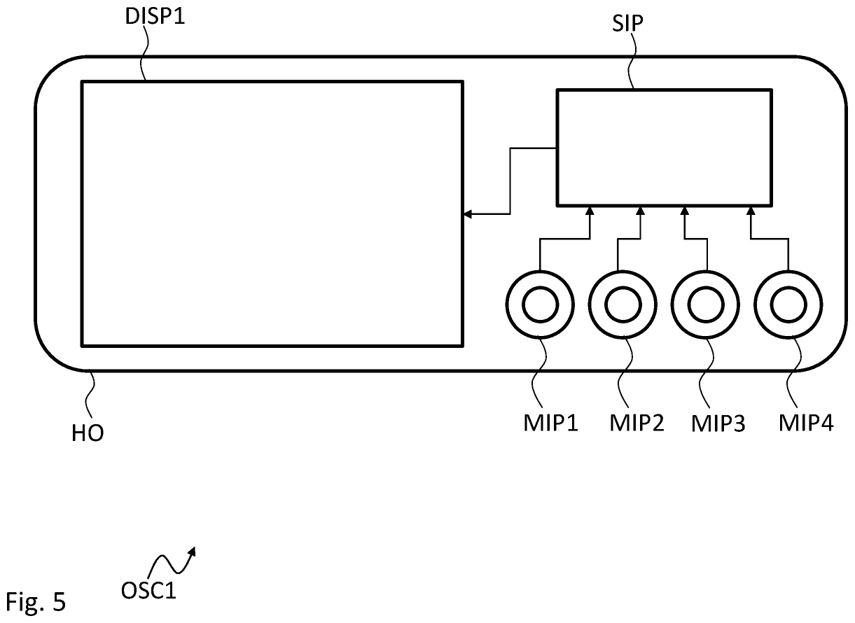

FIG. 5 shows a block diagram of an oscilloscope OSC1 that may be used with an embodiment of a measurement system according to the present disclosure as measurement application device.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

The functionality of the cryptographic data encoder may e.g., be implemented in the signal processor SIP. In embodiments, the signal processor SIP may be provided with respective computer readable instructions or with a respective hardware unit. In other embodiments, the cryptographic data encoder may be provided in addition to the signal processor SIP.

Although not explicitly shown, it is understood, that the oscilloscope OSC1 may also comprise signal outputs that may also be coupled to the differential measurement probe. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

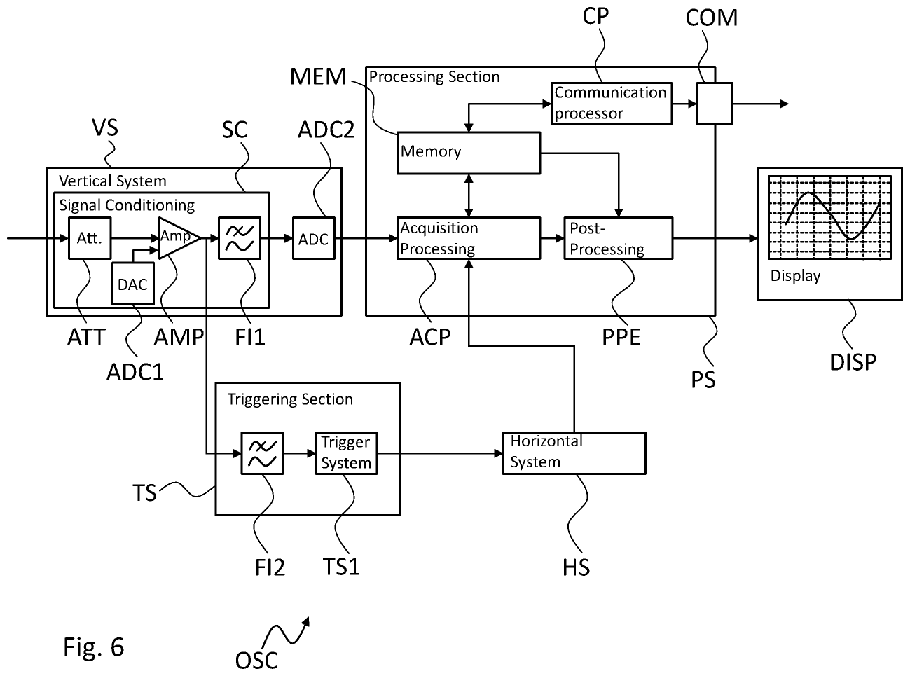

FIG. 6 shows a block diagram of an oscilloscope OSC that may be an implementation of a measurement application device according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way.

The vertical system VS mainly serves for offsetting, attenuating and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP1. The amplifier AMP1 is coupled to a filter FI1, which in the shown example is provided as a low pass filter. The vertical system VS also comprises an analog-to-digital converter ADC1 that receives the output from the filter FI1 and converts the received analog signal into a digital signal.

The attenuator ATT and the amplifier AMP1 serve to scale the amplitude of the signal to be acquired to match the operation range of the analog-to-digital converter ADC1. The digital-to-analog-converter DAC1 serves to modify the DC component of the input signal to be acquired to match the operation range of the analog-to-digital converter ADC1. The filter FI1 serves to filter out unwanted high frequency components of the signal to be acquired.

The triggering section TS operates on the signal as provided by the amplifier AMP. The triggering section TS comprises a filter FI2, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC1 and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC1.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC1 and the output of the horizontal system HS as well as to a memory MEM and a post processing element PPE.

The acquisition processing element ACP manages the acquisition of digital data from the analog-to-digital converter ADC1 and the storage of the data in the memory MEM. The acquisition processing element ACP may for example comprise a processing element with a digital interface to the analog-to-digital converter ADC2 and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The functionality of the cryptographic data encoder may e.g., be implemented in the processing section PS. In embodiments, the processing section PS may comprise a respective hardware unit that implements the cryptographic data encoder. In other embodiments, the cryptographic data encoder may be implemented as addition to or part of any of the adequate elements in the processing section PS. Such an element may be e.g., the communication processor CP, or the acquisition processing element ACP.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

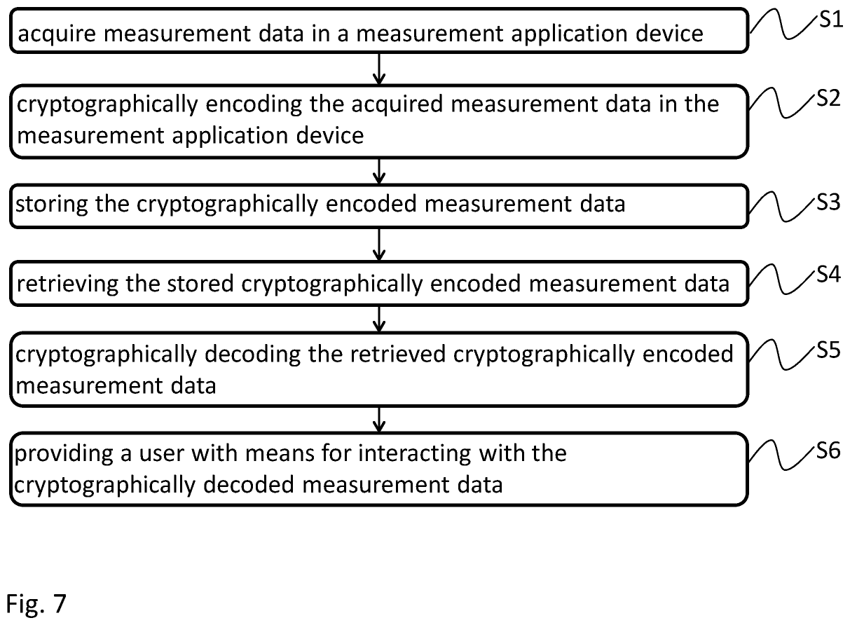

FIG. 7 shows a flow diagram of an embodiment of a method for operating a measurement system.

The method comprises acquiring S1 measurement data in a measurement application device, cryptographically encoding S2 the acquired measurement data in the measurement application device, and storing S3 the cryptographically encoded measurement data. The method further comprises retrieving S4 the stored cryptographically encoded measurement data, cryptographically decoding S5 the retrieved cryptographically encoded measurement data, and providing S6 a user with means for interacting with the cryptographically decoded measurement data.

In order to simplify the management of encryption and decryption keys, in embodiments, the method may comprise at least one of providing a cryptographic encryption key to the measurement application device for cryptographically encoding the measurement data, and providing a cryptographic decryption key for cryptographically decoding the cryptographically encoded measurement data for providing a user with means for interacting with the cryptographically decoded measurement data.

The cryptographic encryption key and the cryptographic decryption key, may in embodiments, be equal. In other embodiments, the cryptographic encryption key and the cryptographic decryption key may be different.

In order to only provide encryption and decryption keys to intended users. the method may comprise at least one of verifying an authenticity of the measurement application device prior to providing the cryptographic encryption key to the cryptographic data encoder, and verify an authenticity of the means for interacting prior to providing the cryptographic decryption key.

Since a user may also work on the measurement data after it is acquired, the method may further comprise cryptographically encoding the measurement data after being manipulated according to respective user input. The measurement data cryptographically encoded after being manipulated according to respective user input may be stored for later use or secure distribution. For cryptographically encoding the measurement data after being manipulated according to respective user input, a cryptographic encryption key may be provided. Such cryptographically encoded measurement data may then be transferred to a remote data storage.

For providing a user with means for interacting with the cryptographically decoded measurement data, in embodiments, the cryptographically encoded measurement data may be retrieved from the remote data storage.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

LIST OF REFERENCE SIGNS

| | |
|---|---|
| 100, 200, 300, 400 | measurement system |
| 101, 201, 301, 401 | measurement application device |
| 102, 202, 302, 402 | measurement data acquisition interface |
| 103, 203, 303, 403 | measurement data |
| 104, 204, 304, 404 | cryptographic data encoder |
| 105, 205, 305, 405 | cryptographically encoded measurement |
| | data |
| 106, 206, 306, 406 | data storage |
| 110, 210, 310, 410 | user interface |
| 111, 211, 311, 411 | measurement data interface |
| 112, 212, 312, 412 | cryptographic data decoder |
| 113, 213, 313, 413 | cryptographically decoded measurement |
| | data |
| 114, 214, 314, 414 | user interaction unit |
| 220 | remote data storage |
| 221, 321, 421 | network |
| 222, 322, 422 | communication interface |
| 330, 430 | cryptographic key database |
| 332, 432 | cryptographic encryption key |
| 333, 433 | cryptographic decryption key |
| 440 | cryptographic data encoder |
| 441 | manipulated and cryptographically |
| | encoded measurement data |
| OSC1 | oscilloscope |
| HO | housing |
| MIP1, MIP2, MIP3, MIP4 | measurement input |
| SIP | signal processing |
| DISP1 | display |
| OSC | oscilloscope |
| VS | vertical system |
| SC | signal conditioning |
| ATT | attenuator |
| DAC1 | analog-to-digital converter |
| AMP1 | amplifier |
| FI1 | filter |
| ADC1 | analog-to-digital converter |
| TS | triggering section |
| AMP2 | amplifier |
| FI2 | filter |
| TS1 | trigger system |
| HS | horizontal system |
| PS | processing section |
| ACP | acquisition processing element |
| MEM | memory |
| PPE | post processing element |
| DISP | display |

1. A measurement system comprising:
a measurement application device comprising:
a measurement data acquisition interface configured to acquire measurement data;
a data storage; and
a cryptographic data encoder coupled to the measurement data acquisition interface and the data storage, wherein the cryptographic data encoder is configured to cryptographically encode the acquired measurement data and to store the cryptographically encoded measurement data in the data storage; and
a user interface comprising:
a measurement data interface configured to retrieve the cryptographically encoded measurement data;
a cryptographic data decoder coupled to the measurement data interface and configured to cryptographically decode the retrieved cryptographically encoded measurement data; and
a user interaction unit configured to provide the user with means for interacting with the cryptographically decoded measurement data.

2. The measurement system according to claim 1, comprising a cryptographic key database configured to at least one of provide a cryptographic encryption key to the cryptographic data encoder for cryptographically encoding the measurement data, and provide a cryptographic decryption key to the cryptographic data decoder for cryptographically decoding the cryptographically encoded measurement data.

3. The measurement system according to claim 2, wherein the cryptographic encryption key and the cryptographic decryption key are equal.

4. The measurement system according to claim 2, wherein the cryptographic encryption key and the cryptographic decryption key are different.

5. The measurement system according to claim 2, wherein the cryptographic key database is configured to at least one of:
verify an authenticity of the measurement application device prior to providing the cryptographic encryption key to the cryptographic data encoder; and
verify an authenticity of the user interface prior to providing the cryptographic decryption key to the cryptographic data decoder.

6. The measurement system according to claim 1, wherein the user interface further comprises a cryptographic data encoder coupled to the user interaction unit and configured to cryptographically encode the measurement data after being manipulated in the user interaction unit according to respective user input.

7. The measurement system according to claim 6, wherein the cryptographic data encoder in the user interface is coupled to the measurement data interface and is configured to output the manipulated and cryptographically encoded measurement data via the measurement data interface.

8. The measurement system according to claim 6, comprising a cryptographic key database configured to provide a cryptographic encryption key to the cryptographic data encoder of the user interface for cryptographically encoding the measurement data.

9. The measurement system according to claim 1, comprising a remote data storage communicatively coupled at least to the measurement application device, wherein the measurement application device is configured to transmit the cryptographically encoded measurement data to the remote data storage.

10. The measurement system according to claim 9, wherein the user interface is configured to retrieve the cryptographically encoded measurement data from the remote data storage.

11. A method for operating a measurement system, the method comprising:
acquiring measurement data in a measurement application device;
cryptographically encoding the acquired measurement data in the measurement application device;
storing the cryptographically encoded measurement data in the measurement application device;
retrieving the stored cryptographically encoded measurement data;
cryptographically decoding the retrieved cryptographically encoded measurement data; and
providing a user with means for interacting with the cryptographically decoded measurement data.

12. The method according to claim 11, comprising at least one of providing a cryptographic encryption key to the measurement application device for cryptographically encoding the measurement data, and providing a cryptographic decryption key for cryptographically decoding the cryptographically encoded measurement data for providing a user with means for interacting with the cryptographically decoded measurement data.

13. The method according to claim 12, wherein the cryptographic encryption key and the cryptographic decryption key are equal.

14. The method according to claim 12, wherein the cryptographic encryption key and the cryptographic decryption key are different.

15. The method according to claim 12, comprising at least one of:
verifying an authenticity of the measurement application device prior to providing the cryptographic encryption key to a cryptographic data encoder; and
verifying an authenticity of the means for interacting prior to providing the cryptographic decryption key.

16. The method according to claim 11, further comprising cryptographically encoding the measurement data after being manipulated according to respective user input.

17. The method according to claim 16, wherein the measurement data cryptographically encoded after being manipulated according to respective user input is stored.

18. The method according to claim 16, comprising providing a cryptographic encryption key for cryptographically encoding the measurement data after being manipulated according to respective user input.

19. The method according to claim 11, wherein the cryptographically encoded measurement data is transferred to a remote data storage.

20. The method according to claim 19, wherein for providing a user with means for interacting with the cryptographically decoded measurement data the cryptographically encoded measurement data is retrieved from the remote data storage.

21. A measurement application device comprising:
a measurement data acquisition interface configured to acquire measurement data;
a data storage; and
a cryptographic data encoder coupled to the measurement data acquisition interface and the data storage, wherein the cryptographic data encoder is configured to cryptographically encode the acquired measurement data and to store the cryptographically encoded measurement data in the data storage.
